(19) United States
(12) Patent Application Publication
(10) Pub. No.: US 2020/0192150 A1
(43) Pub. Date: Jun. 18, 2020

(54) Display Device

(71) Applicants: HEFEI XINSHENG OPTOELECTRONICS TECHNOLOGY CO., LTD., Hefei, Anhui (CN); BOE TECHNOLOGY GROUP CO., LTD., Beijing (CN)

(72) Inventor: Liangliang JIANG, Beijing (CN)

(21) Appl. No.: 16/642,669

(22) PCT Filed: Mar. 15, 2019
(86) PCT No.: PCT/CN2019/078341

§ 371 Date: Feb. 27, 2020

(30) Foreign Application Priority Data
Mar. 27, 2018 (CN) 201810258662.7

(51) Int. Cl. G02F 1/1335; G02F 1/13357

(52) U.S. Cl. CPC G02F 1/133514; G02F 1/133621; G02F 1/133603

(57) ABSTRACT

The disclosure provides a display device including an array substrate; a color filter substrate comprising a color resist layer, the color resist layer comprising a red resist, a green resist and a blue resist; a liquid crystal layer between the array substrate and the color filter substrate; and a backlight source on a side of the array substrate distal to the liquid crystal layer, wherein the liquid crystal layer has a cell gap of 2.0 μm to 3.3 μm; at least the red resist and the green resist are filled with light emitting materials; respectively; the backlight source is configured to generate a light having a wavelength of 200 nm to 450 nm, and the red resist, the green resist and the blue resist are configured such that the light is able to become red light, green light and blue light, respectively after passing through corresponding color resists.

### CROSS REFERENCE TO RELATED APPLICATION

This application claims priority to Chinese patent application No. 201810258662.7, filed on Mar. 27, 2018, the entire contents of which are incorporated herein by reference.

### TECHNICAL FIELD

The present disclosure relates to the field of display technologies, and in particular, to a display device.

### BACKGROUND

A TFT-LCD (Thin Film Transistor-Liquid Crystal Display) is a passive light emitting panel display device, in which liquid crystal molecules cannot emit light by themselves and have to work with a backlight source for normal operation.

### SUMMARY

The present disclosure provides a display device including: an array substrate; a color filter substrate including a color resist layer, the color resist layer including a red resist, a green resist and a blue resist; a liquid crystal layer between the array substrate and the color filter substrate; a backlight source on a side of the array substrate distal to the liquid crystal layer, wherein the liquid crystal layer has a cell gap of 2.0 μm to 3.3 μm; at least the red resist and the green resist are filled with light emitting materials, respectively; the backlight source is configured to generate a light having a wavelength of 200 nm to 450 nm, and the red resist, the green resist and the blue resist are configured such that the light is able to become red light, green light and blue light, respectively after passing through the corresponding color resists.

According to an embodiment of the present disclosure, the backlight source is configured to generate a light having a wavelength of 400 nm to 450 nm.

According to an embodiment of the present disclosure, the cell gap of the liquid crystal layer and the backlight source satisfy the following condition: Δnd/λ=½; where Δn is a birefringence of the liquid crystal layer, d is the cell gap of the liquid crystal layer, and λ is the wavelength of the light generated by the backlight source.

According to an embodiment of the present disclosure, the wavelength of the light generated by the backlight source is substantially 440 nm, the cell gap of the liquid crystal layer is 2.2 μm, and the birefringence of the liquid crystal layer is 0.1.

According to an embodiment of the present disclosure, the red resist, the green resist and the blue resist are filled with light emitting materials, respectively.

According to an embodiment of the present disclosure, the red resist, the green resist and the blue resist are filled with a red phosphor powder, a green phosphor powder and a blue phosphor powder of different models, respectively, and the red phosphor powder is configured to generate red light under excitation of the light generated by the backlight source, the green phosphor powder is configured to generate green light under excitation of the light generated by the backlight source, and the blue phosphor powder is configured to generate blue light under excitation of the light generated by the backlight source.

According to an embodiment of the present disclosure, the red resist and the green resist are filled with a red phosphor powder and a green phosphor powder of different models, respectively, the blue resist includes a blue filter, the red phosphor powder is configured to generate red light under excitation of the light generated by the backlight source, and the green phosphor powder is configured to generate green light under excitation of the light generated by the backlight source.

According to an embodiment of the present disclosure, the red resist, the green resist and the blue resist are filled with a first quantum dot material, a second quantum dot material and a third quantum dot material, respectively, the first quantum dot material has a luminescent spectrum in a red light waveband, the second quantum dot material has a luminescent spectrum in a green light waveband, and the third quantum dot material has a luminescent spectrum in a blue light waveband.

According to an embodiment of the present disclosure, the red resist and the green resist are filled with a first quantum dot material and a second quantum dot material, respectively, the blue resist includes a blue filter, the first quantum dot material has a luminescent spectrum in a red light waveband, and the second quantum dot material has a luminescent spectrum in a green light waveband.

According to an embodiment of the present disclosure, the first quantum dot material, the second quantum dot material and the third quantum dot material are all CdSe.

According to an embodiment of the present disclosure, particle radii of the CdSe are 1.35 nm to 2.40 nm, and a particle radius of CdSe serving as the first quantum dot material is greater than a particle radius of CdSe serving as the second quantum dot material, and the particle radius of the CdSe serving as the second quantum dot material is greater than a particle radius of CdSe serving as the third quantum dot material.

According to an embodiment of the present disclosure, the color resist layer further includes a white resist or a yellow resist, the white resist or the yellow resist is filled with a white phosphor powder or a yellow phosphor powder, and the white phosphor powder or the yellow phosphor powder is configured to generate white light or yellow light under excitation of the light generated by the backlight source.

According to an embodiment of the present disclosure, the color resist layer further includes a white resist or a yellow resist, the white resist or the yellow resist is filled with a fourth quantum dot material, and the fourth quantum dot material is configured to generate white light or yellow light under excitation of the light generated by the backlight source.

According to an embodiment of the present disclosure, the color resist layer further includes a white resist or a yellow resist, the white resist or the yellow resist is filled with a fourth quantum dot material, and the fourth quantum dot material has a luminescent spectrum in a white light waveband or a yellow light waveband.

According to an embodiment of the present disclosure, the backlight includes a light emitting chip.

According to an embodiment of the present disclosure, the display device is an FFS or IPS display device.

### BRIEF DESCRIPTION OF THE DRAWINGS

FIG. 1 is a schematic structural diagram of a display device in the related art; and

FIG. 2 is a schematic structural diagram of a display device provided in the present disclosure.

### DETAILED DESCRIPTION

The technical solutions in the present disclosure will be described clearly and completely with reference to the accompanying drawings in the present disclosure, and apparently, the described embodiments are some but not all of the embodiments of the present disclosure. All other embodiments derived from the embodiments disclosed in the present disclosure by a person skilled in the art without creative effort shall fall within the protection scope of the present disclosure.

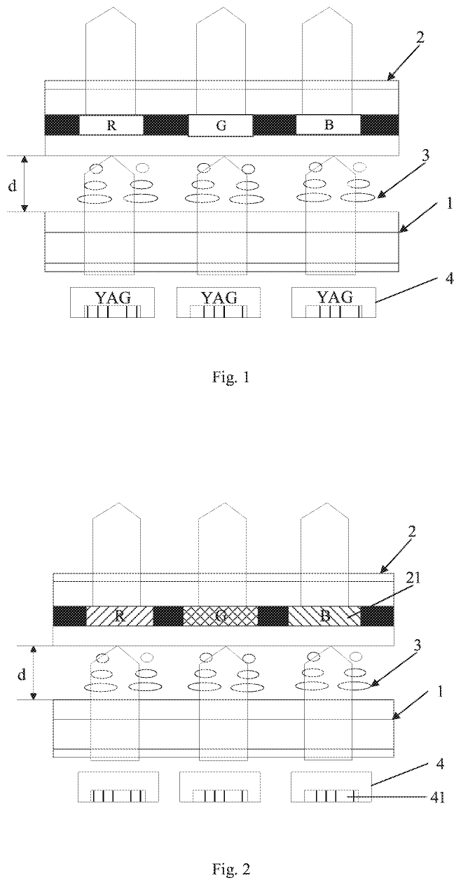

An existing display device, as shown in FIG. 1, includes a backlight source 4, an array substrate 1, a color filter substrate 2, and a liquid crystal layer 3 filled between the array substrate 1 and the color filter substrate 2. The backlight source 4 uses a chip (e.g., LED) generating blue light and a yellow phosphor powder YAG that cooperate with each other to emit white light, and the color filter substrate 2 includes color filters such that the white light becomes light of corresponding colors after passing through the color filters of different colors, respectively. The white light emitted by the backlight source 4 sequentially penetrates through the array substrate 1 and the liquid crystal layer 3 and is filtered by the color filters in the color filter substrate 2 to realize full-color display. In an embodiment, the cell gap d of the liquid crystal layer is about 3.0 μm to 3.5 μm, the retardation Δnd of the liquid crystal is between 300 nm and 350 nm, and the wavelength k of the backlight (i.e. white light) emitted by the backlight source is 600 nm to 700 nm under the condition that the transmittance of the liquid crystal is the maximum.

With the application of high driving frequencies of 120 Hz and 240 Hz and the appearance of products such as Augmented Reality (AR) and Virtual Reality (VR) products, the requirement on the response time of the liquid crystal display device is getting stricter and stricter.

In order to increase the response speed of the liquid crystal, the cell gap of the liquid crystal layer is decreased to 1.5 μm to 2 μm in the related art, in this way, the response time of the liquid crystal is greatly reduced, but as a result the transmittance is reduced. Therefore, this solution can only be applied to products with a low requirement on the transmittance.

The liquid crystal display device generally includes a FFS (Fringe Field Switching) display device or an IPS (In-Plane Switching) display device. One of the key parameters of the liquid crystal display device is the transmittance of liquid crystal, which is calculated using the following formula (1):

Tr.=½ sin²(2ψ)×sin²(πΔnd/λ) (1)

where Tr. is the transmittance of the liquid crystal, ψ is the phase angle of the liquid crystal (the angle between the transmission axes of the liquid crystal and the polarizer), Δn is the birefringence of the liquid crystal, d is the cell gap of the liquid crystal layer, Δnd is the retardation of the liquid crystal, and λ is the wavelength of backlight. In order to maximize the transmittance of the liquid crystal, generally, the phase angle of the liquid crystal is designed to be 45°, and the retardation Δnd of the liquid crystal is λ/2, and is generally between 300 nm and 350 nm.

Another key parameter of the liquid crystal display device is the response time of the liquid crystal, which includes a rising time τr during which the luminance increases from 10% to 90% and a falling time τf during which the luminance decreases from 90% to 10%.

The rising time τr is calculated using the following formula (2):

τr=γₗd²/[ε₀ Δε(E−Eth)²] (2)

The falling time τf is calculated using the following formula (3):

τf=γₗd²/π ²K (3)

where γₗ is the rotation viscosity of the liquid crystal, d is the cell gap of the liquid crystal layer, ε₀ o is the vacuum dielectric constant, Δε is the dielectric constant of the liquid crystal, K is the elastic coefficient of the liquid crystal, E is the voltage applied to the display device, and Eth is the threshold voltage of the liquid crystal layer.

The inventors found that the response speed of the liquid crystal layer can be increased by decreasing the cell gap d of the liquid crystal layer and the transmittance Tr, of the liquid crystal and the retardation Δnd of the liquid crystal depend on the wavelength λ. Therefore, as the cell gap d of the liquid crystal layer decreases, the retardation Δnd of the liquid crystal decreases, and the wavelength corresponding to the maximum transmittance of the liquid crystal decreases. By simply reducing the cell gap d of the liquid crystal layer, the response speed of the liquid crystal can be greatly improved (the rising time and the falling time are reduced), but blue shift occurs to the wavelength λ of the backlight corresponding to the highest light efficiency of the liquid crystal because the retardation Δnd of the liquid crystal is simultaneously reduced. In a case where a conventional backlight source is still used as an excitation light source (the backlight emitted by the conventional backlight source is white light with the wavelength λ of the range of 380 nm to 780 nm), and no corresponding adjustment is made, it is inevitable that the retardation Δnd of the liquid crystal does not match with the wavelength λ of the backlight, so that the light efficiency and the transmittance of the liquid crystal are greatly reduced. Therefore, on the premise of reducing the cell gap d of the liquid crystal layer, it is necessary to adjust the backlight source, and the wavelength λ of the backlight is correspondingly reduced to match with the retardation Δnd of the liquid crystal, so as to improve the transmittance of the display device.

Accordingly, the present disclosure provides a display device, as shown in FIG. 2, the display device includes: an array substrate 1, a color filter substrate 2, a liquid crystal layer 3 between the array substrate 1 and the color filter substrate 2, and a backlight source 4 on a side of the array substrate 1 distal to the liquid crystal layer 3. The liquid crystal layer 3 has a cell gap with the range of 2.0 μm to 3.3 μm, and the backlight source 4 is configured to generate a light having a wavelength in the range of 200 nm to 450 nm. The color filter substrate 2 includes a color resist layer 21, and the color resist layer 21 includes a plurality of red resists R, a plurality of green resists G, and a plurality of blue resists B. According to an embodiment of the present disclosure, the red resist R, the green resist G, and the blue resist B are filled with light emitting materials, respectively, and the light emitting materials are configured such that the light becomes red light, green light, and blue light after passing through the red resist R, the green resist G, and the blue resist B, respectively.

According to another embodiment of the present disclosure, the backlight source 4 is configured to generate blue light, and only the red resist R and the green resist G are filled with light emitting materials, and the light emitting materials are configured such that the light becomes red light and green light after passing through the red resist R and the green resist G, respectively. Accordingly, the blue resist may be a blue light-transmissive layer, e.g., a blue filter.

In the present disclosure, the cell gap d of the liquid crystal layer is set to be in the range of 2.0 μm to 3.3 μm. Compared with the existing display device, the cell gap d of the liquid crystal layer is reduced, the wavelength of the light generated by the backlight source 4 is in the range of 200 nm to 450 nm, and the light having the wavelength in this range is blue light and near ultraviolet light. That is, compared with the existing display device, the wavelength of the backlight is reduced. Because the backlight emitted by the existing backlight source 4 is white light, and accordingly, color display can be realized by providing color filters to respectively filtering red light, green light and blue light, whereas the backlight emitted by the backlight source 4 of the present disclosure is blue light and near ultraviolet light, and accordingly, the light emitting materials need to be filled in the color resist layer 21 to replace those in existing color filters to realize color display.

In the display device disclosed in the present disclosure, by reducing the cell gap d of the liquid crystal layer, the retardation Δnd of the liquid crystal can be correspondingly reduced, and by reducing the wavelength λ of the backlight emitted by the backlight source 4, the wavelength can match with the retardation Δnd of the liquid crystal. It can be known from the calculation formula Tr.=½ sin²(2ψ)*sin²(π Δnd/λ) for the transmittance of the liquid crystal that the transmittance and the light efficiency of the liquid crystal layer of the display device can be increased, so that both the response time and the transmittance of the liquid crystal can be taken into consideration. Therefore, the backlight source 4 emits backlight having a short wavelength, the light efficiency and the transmittance can still be maximized after the backlight is regulated by the liquid crystal layer 3 as a light-regulating valve, and the response time is greatly reduced. The color resist layer 21 of the color filter substrate 2 is filled with a light emitting material, and the light emitting material in the color resist layer of the color filter substrate is excited by light passing through the liquid crystal layer, so that grayscale regulation and full-color display are realized.

According to an embodiment of the present disclosure, the backlight source 4 includes a light emitting chip 41, and the light emitting chip 41 is configured to generate a light with a wavelength λ in the range of 200 nm to 450 nm (including near ultraviolet light and blue light).

In an embodiment of the present disclosure, the color resist layer 21 may include three types of color resists, namely, the red resist R, the green resist G and the blue resist B, and the red resist R, the green resist G and the blue resist B are filled with light emitting materials of a same type but different models, respectively. In an embodiment, the red resist R, the green resist G and the blue resist B are filled with a red phosphor powder, a green phosphor powder and a blue phosphor powder, respectively. The light generated by the backlight source 4 can excite the red phosphor powder to generate red light, excite the green phosphor powder to generate green light and excite the blue phosphor powder to generate blue light. The models of red, green, and blue phosphor powders depend on the wavelength λ of the backlight emitted by the backlight source 4 such that they produce light of a desired under excitation of the light emitted by the backlight source. Alternatively, in a case where the light emitted by the backlight source 4 is blue light, the blue resist may not be filled with phosphor powder.

Alternatively, the red resist R, the green resist G and the blue resist B are filled with quantum dot materials. In an embodiment, the red resist R, the green resist G and the blue resist B are filled with a first quantum dot material, a second quantum dot material and a third quantum dot material, respectively. The luminescent spectrum of the first quantum dot material is in the red light waveband, the luminescent spectrum of the second quantum dot material is in the green light waveband, the luminescent spectrum of the third quantum dot material is in the blue light waveband, which can be realized by selecting a quantum dot material with a proper type and suitable particle sizes. According to an embodiment of the present disclosure, the first to third quantum dot materials are all CdSe. The particle radii of the CdSe are in the range of 1.35 nm to 2.40 nm, a particle radius of the CdSe serving as the first quantum dot material is larger than a particle radius of the CdSe serving as the second quantum dot material, and the particle radius of the CdSe serving as the second quantum dot material is larger than a particle radius of the CdSe serving as the third quantum dot material, so that the luminescent spectrum of the first quantum dot material is in the red light waveband, the luminescent spectrum of the second quantum dot material is in the green light waveband, and the luminescent spectrum of the third quantum dot material is in the blue light waveband.

That is to say, the red resist R, the green resist G and the blue resist B are filled with phosphor powders of different models, or the red resist R, the green resist G and the blue resist B are filled with quantum dot materials of different types or a quantum dot material of a same type but having different sizes, which facilitates control of color of light emitted from each color resist when the wavelength of the backlight emitted by the backlight source 4 is fixed. Needless to say, those skilled in the art will appreciate that the light emitting materials filled in the red resist R, the green resist G and the blue resist B may be of different types, as long as the light emitting materials in respective color resists can respectively generate red light, green light and blue light when being excited by the backlight. For example, light emitting materials filled in part of the red resist R, the green resist G and the blue resist B are phosphor powders of different models, and a light emitting material filled in the other part is a quantum dot material.

In another embodiment of the present disclosure, the color resist layer 21 includes four types of color resists, namely, red resist R, green resist G, blue resist B and white resist W, or red resist R, green resist G, blue resist B and yellow resist Y. The white resist W or the yellow resist Y is filled with a light emitting material, and the light generated by the backlight source 4 can excite the light emitting material in the white resist W or the yellow resist Y to generate white light or yellow light. According to an embodiment of the present disclosure, the light emitting material in the white resist W or the yellow resist Y is of the same type as the light emitting material in the red resist R, the green resist G and the blue resist B, for example, a phosphor powder of a different model.

That is to say, different models of phosphor powders are filled in the red resist R, the green resist G, the blue resist B and the white resist W, or different models of phosphor powders are filled in the red resist R, the green resist G, the blue resist B and the yellow resist Y, so that when the wavelength λ of the backlight emitted by the backlight source 4 is fixed, colors of light emitted from respective color resists can be conveniently controlled.

Alternatively, quantum dot materials of different types or quantum dot materials of a same type but having different sizes are filled in the red resist R, the green resist G and the white resist W. Similarly, quantum dot materials of different types or quantum dot materials of a same type but having different sizes are filled in the red resist R, the green resist G and the yellow resist Y, so that when the wavelength λ of the backlight emitted by the backlight source 4 is fixed, color of light emitted from each color resist can be conveniently controlled.

Needless to say, those skilled in the art will appreciate that the light emitting materials filled in the red resist R, the green resist G, the blue resist B, the white resist W, and the yellow resist Y may be of different types, as long as the light emitting materials in the respective color resists can generate red light, green light, blue light, and white light, respectively, or generate red light, green light, blue light, and yellow light, respectively, when being excited by the backlight. For example, light emitting materials filled in one part of the red resist R, the green resist G, the blue resist B and the white resist W are phosphor powders of different models, and a light emitting material filled in the other part is a quantum dot material. Similarly, light emitting materials filled in one part of the red resist R, the green resist G; the blue resist B and the yellow color resist Y are phosphor powders of different models, and a light emitting material filled in the other part is a quantum dot material.

According to an embodiment of the present disclosure, as shown in FIG. 2, the cell gap d of the liquid crystal layer 3 and the backlight source 4 satisfy the following condition: Δnd/λ=½; where Δn is the birefringence of the liquid crystal layer 3, d is the cell gap of the liquid crystal layer 3, and λ is the wavelength of the light generated by the backlight source 4. It can be known from the calculation formula Tr=½ sin²(2ψ)×sin²(π Δnd/λ) for the transmittance of the liquid crystal that when the cell gap d of the liquid crystal layer 3 and the backlight 4 satisfy the above condition, the transmittance of the liquid crystal is the maximum, and the liquid crystal layer 3 can achieve the maximum light efficiency.

According to an embodiment of the present disclosure, the cell gap d of the liquid crystal layer 3 is set to be 2.2 μm, the birefringence Δn of the liquid crystal layer 3 is 0.1, and the retardation Δnd of the liquid crystal is equal to 220 nm. According to the formula (2) and the formula (3), because the cell gap d of the liquid crystal layer 3 is decreased from 3.3 μm to 2.2 μm, the response time of the liquid crystal can be reduced by about 55.5%.

As can be seen from the formula (1), the liquid crystal has the maximum light efficiency and transmittance in the case of blue light having a wavelength λ equal to 440 nm (2 Δnd), and therefore, a chip capable of emitting blue light having the wavelength λ substantially equal to 440 nm is selected as the backlight source 4. That is, according to the embodiment of the present disclosure, the wavelength λ of the light generated by the backlight source 4 is substantially 440 nm, the cell gap d of the liquid crystal layer 3 is 2.2 μm, and the birefringence Δn of the liquid crystal layer 3 is 0.1.

According to an embodiment of the present disclosure, the display device is an FFS or IPS display device.

The display device may be any product or component with a display function, such as an electronic paper, a mobile phone, a tablet computer, a display, a notebook computer, a digital photo frame, a navigator and the like.

According to the liquid crystal display device of the present disclosure, the cell gap of the liquid crystal layer is relatively small, the retardation is relatively small accordingly, the wavelength of the backlight emitted by the backlight source when the light efficiency of the liquid crystal reaches the maximum is adjusted, and suitable light emitting materials in the color resists are selected according to the adjusted wavelength of the backlight. As such, under the premise of reducing the cell gap of the liquid crystal layer, the response time of the liquid crystal can be greatly reduced without adversely affecting the light efficiency and the transmissivity of the liquid crystal.

It could be understood that the above implementations are merely exemplary implementations employed to illustrate the principle of the present disclosure, and the present disclosure is not limited thereto. Various variations and improvements can be made by those skilled in the art without departing from the spirit and scope of the present disclosure, and these variations and improvements are also considered to be within the protection scope of the present disclosure.

1-16. (canceled)

17. A display device, comprising:
an array substrate;
a color filter substrate comprising a color resist layer, the color resist layer comprising a red resist, a green resist and a blue resist;
a liquid crystal layer between the array substrate and the color filter substrate; and
a backlight source on a side of the array substrate distal to the liquid crystal layer, wherein
the liquid crystal layer has a cell gap of 2.0 μm to 3.3 μm; at least the red resist and the green resist are filled with light emitting materials, respectively;
the backlight source is configured to generate a light having a wavelength of 200 nm to 450 nm, and
the red resist, the green resist and the blue resist are configured such that the light is able to become red light, green light and blue light, respectively after passing through the corresponding color resists.

18. The display device of claim 17, wherein the backlight source is configured to generate a light having a wavelength of 400 nm to 450 nm.

19. The display device of claim 18, wherein the cell gap of the liquid crystal layer and the backlight source satisfy the following condition: Δnd/λ=½; where Δn is a birefringence of the liquid crystal layer, d is the cell gap of the liquid crystal layer, and λ, is the wavelength of the light generated by the backlight source.

20. The display device of claim 19, wherein the wavelength of the light generated by the backlight source is substantially 440 nm, the cell gap of the liquid crystal layer is 2.2 μm, and the birefringence of the liquid crystal layer is 0.1.

21. The display device of claim 17, wherein the red resist, the green resist and the blue resist are filled with light emitting materials, respectively.

22. The display device of claim 17, wherein the red resist, the green resist and the blue resist are filled with a red phosphor powder, a green phosphor powder and a blue phosphor powder of different models, respectively, and
the red phosphor powder is configured to generate red light under excitation of the light generated by the backlight source, the green phosphor powder is configured to generate green light under excitation of the light generated by the backlight source, and the blue phosphor powder is configured to generate blue light under excitation of the light generated by the backlight source.

23. The display device of claim 18, wherein the red resist and the green resist are filled with a red phosphor powder and a green phosphor powder of different models, respectively, and the blue resist comprises a blue filter, and
the red phosphor powder is configured to generate red light under excitation of the light generated by the backlight source, and the green phosphor powder is configured to generate green light under excitation of the light generated by the backlight source.

24. The display device of claim 17, wherein the red resist, the green resist and the blue resist are filled with a first quantum dot material, a second quantum dot material and a third quantum dot material, respectively, and
the first quantum dot material has a luminescent spectrum in a red light waveband, the second quantum dot material has a luminescent spectrum in a green light waveband, and the third quantum dot material has a luminescent spectrum in a blue light waveband.

25. The display device of claim 18, wherein the red resist and the green resist are filled with a first quantum dot material and a second quantum dot material, respectively, and the blue resist comprises a blue filter, and
the first quantum dot material has a luminescent spectrum in a red light waveband, and the second quantum dot material has a luminescent spectrum in a green light waveband.

26. The display device of claim 24, wherein the first quantum dot material, the second quantum dot material and the third quantum dot material are all CdSe.

27. The display device of claim 26, wherein particle radii of the CdSe are 1.35 nm to 2.40 nm, a particle radius of CdSe serving as the first quantum dot material is greater than a particle radius of CdSe serving as the second quantum dot material, and the particle radius of the CdSe serving as the second quantum dot material is greater than a particle radius of CdSe serving as the third quantum dot material.

28. The display device of claim 22, wherein the color resist layer further comprises a white resist or a yellow resist, the white resist or the yellow resist is filled with a white phosphor powder or a yellow phosphor powder, and the white phosphor powder or the yellow phosphor powder is configured to generate white light or yellow light under excitation of the light generated by the backlight source.

29. The display device of claim 24, wherein the color resist layer further comprises a white resist or a yellow resist, the white resist or the yellow resist is filled with a fourth quantum dot material, and the fourth quantum dot material has a luminescent spectrum in a white light waveband or in a yellow light waveband.

30. The display device of claim 17, wherein the backlight comprises a light emitting chip.

31. The display device of claim 19, wherein the display device is an FFS or IPS display device.
